(19) United States
(12) Patent Application Publication
(10) Pub. No.: US 2007/0150489 A1
(43) Pub. Date: Jun. 28, 2007

(54) Method of representing continuum of data as a rolling column within a relational model

(75) Inventors: Richard D. Dettinger, Rochester, MN (US); Daniel P. Kolz, Rochester, MN (US); Richard J. Stevens, Rochester, MN (US)

Correspondence Address: IBM CORPORATION, INTELLECTUAL PROPERTY LAW;DEPT 917, BLDG. 006-1, 3605 HIGHWAY 52 NORTH, ROCHESTER, MN, 55901-7829, US

(73) Assignee: INTERNATIONAL BUSINESS MACHINES CORPORATION, ARMONK, NY (US)

(21) Appl. No.: 11/316,246

(22) Filed: Dec. 22, 2005

(51) Int. Cl. G06F 7/00

(52) U.S. Cl. 707/100

(57) ABSTRACT

A method and apparatus for representing a continuum of data as a rolling column within a relational model is disclosed. Data from a continuous data source may be used to populate a rolling column. Metadata defining the rolling column specifies the correct portion of data from the continuum of data that should be used to populate the rolling column. Whenever data from the rolling column is included in a data access request, such as a database query, a database management system may be configured to update the rolling column, according to the metadata.

### BACKGROUND OF THE INVENTION

1. Field of the Invention

The present invention is generally directed to computer databases. More specifically, the present invention is directed to representing a time- or volume-oriented portion of data as a rolling column within a database.

2. Description of the Related Art

Databases are computerized information storage and retrieval systems. A relational database management system (RDBMS) is a computer database management system that uses relational techniques for storing and retrieving data. Relational databases are computerized information storage and retrieval systems in which data is stored in the form of tables (formally denominated “relations”) in disk drives or similar mass data stores. A “table” includes a set of rows (formally denominated “tuples” or “records”) spanning several columns (formally denominated “attributes”).

A RDBMS is structured to accept commands to store, retrieve and delete data using, for example, high-level query languages such as the Structured Query Language (SQL). The term “query” denominates a set of commands for retrieving data from a stored database. These queries may come from users, application programs, or remote systems (clients or peers). The method of query execution is typically called a query plan, an access plan, or just “plan,” which provides an ordered set of steps used to access information in a relational database. There are typically many different useful execution plans for any particular query, each of which returns the correct data set. For large databases, the query plan is selected to provide a query result at a reasonable cost relative to time and hardware resources required to perform the plan.

A number of applications generate data that may be stored as a series of values measured at specific points in time or that is related to a specific series of events. These discrete points may represent a continuum of data. For example, real-time monitoring systems for different sensing devices may monitor a diverse variety of continuous events such as patient vital signs, atmospheric weather conditions, and current stock prices, to give a few examples. Each of these data sources may provide data stored as records in the RDBMS.

Portions of this data are often useful to data mining and analysis programs designed to analyze data stored in a relational database, e.g., stock performance analysis applications. Because the continuum of data may be in a constant state of flux, a number of issues arise for applications that rely on data from a relational database. First, storing a real-time or near-continuous data feed in a relational data model requires making continuous inserts of data. When a portion or slice of the data is needed, no efficient method currently exists to define how much of the data to accumulate or provide to an application processing data from the RDBMS. In other words, an application processing the real-time data must be configured to select a particular sub-section or slice of the data for processing.

While it may be possible to configure some applications in this manner, one drawback to this approach is that it often results in relationships between the RDBMS and data-consuming applications that are neither scaleable nor efficient. Another approach includes using data abstraction techniques. However, using data abstraction may become unwieldy due to the amount of information each application must have about the structure of the real-time data in order to obtain a relevant sub-section. Further, in either approach, costly changes to application code may be required each time the data model in the RDBMS changes even slightly.

Accordingly, there is a need for a method for representing data from real-time or near-continuous data sources within a relational database model.

### SUMMARY OF THE INVENTION

The present invention is generally directed to a system, method, and article of manufacture for representing a particular time- or volume-oriented slice of data as a “rolling column” within a relational database model.

One embodiment of the invention provides a computer-implemented method for representing, within a relational model, a continuum of data received from an external data source. The method generally includes defining a set of metadata parameters that define a portion of the continuum of data to store in a rolling column. In response to receiving a query that includes a reference to the rolling column, the method generally further includes retrieving the metadata parameters defining the portion of the continuum of data to store in the rolling column, conditionally, updating data values stored in the rolling column to reflect a correct portion of the continuum of data, according to the metadata parameters, and processing the database query against the updated rolling column.

Another embodiment of the invention includes a computer-readable storage medium containing a program which, when executed by a processor, performs operations for representing, within a relational model, a continuum of data received from an external data source. The operations generally include, in response to receiving a query that includes a reference to a rolling column, retrieving metadata parameters defining a portion of the continuum of data to store in the rolling column, conditionally, updating data values stored in the rolling column to reflect a correct portion of the continuum of data, according to the metadata parameters, and processing the database query against the updated rolling column.

Another embodiment of the invention includes a computing device. The computing device generally includes a processor and a memory configured to store an application that includes instructions which, when executed, cause the processor to perform operations for representing continuum of data received from an external data source as a rolling column within a relational model. In response to receiving a query that includes a reference to the rolling column, the operations generally include, (i) retrieving metadata parameters defining a portion of the continuum of data to store in the rolling column, (ii) conditionally, updating data values stored in the rolling column to reflect a correct portion of the continuum of data, according to the metadata parameters, and (iii) processing the database query against the updated rolling column.

### BRIEF DESCRIPTION OF THE DRAWINGS

So that the manner in which the above recited features, advantages and objects of the present invention are attained and can be understood in detail, a more particular description of the invention, briefly summarized above, may be had by reference to the embodiments illustrated in the appended drawings.

Note, however, that the appended drawings illustrate only typical embodiments of this invention and are therefore not to be considered limiting of its scope, for the invention may admit to other equally effective embodiments.

FIG. 1 is a block diagram illustrating a general purpose computer system used in accordance with the invention.

FIG. 2 is a relational view of a database environment configured to store a continuum of data as a rolling column within a relational model, according to one embodiment of the invention.

FIG. 3 is a flow chart illustrating the operation of a runtime component configured, according to one embodiment of the invention.

FIG. 4 is a flow chart further illustrating the operation of a runtime component, according to one embodiment of the invention.

FIG. 5 is a flow chart further illustrating the operation of a runtime component, according to one embodiment of the invention.

FIG. 6 illustrates an example metadata schema that defines a rolling column within a relational database, according to one embodiment of the invention.

FIG. 7 illustrates a database schema with an exemplary view of a database table that includes a rolling column, according to one embodiment of the invention.

FIG. 8 illustrates database schemas with exemplary views of a database table that includes rolling columns, according to one embodiment of the invention.

### DETAILED DESCRIPTION OF THE PREFERRED EMBODIMENTS

The present invention is generally directed to a system, method, and article of manufacture for representing a particular time- or volume-oriented slice of data as a “rolling column” within a relational database model. One embodiment is directed to managing data from an external data source through the use of metadata describing a new column type (this new column type is referred to herein as a “rolling column”). In one embodiment, the metadata describes the rolling column, how the data is obtained for rolling column, and the portion of data available to the rolling column used both by external applications and for processing queries that reference the rolling column. In one embodiment, external applications request data from the rolling column using SQL queries in the same manner used to retrieve data from existing database column types.

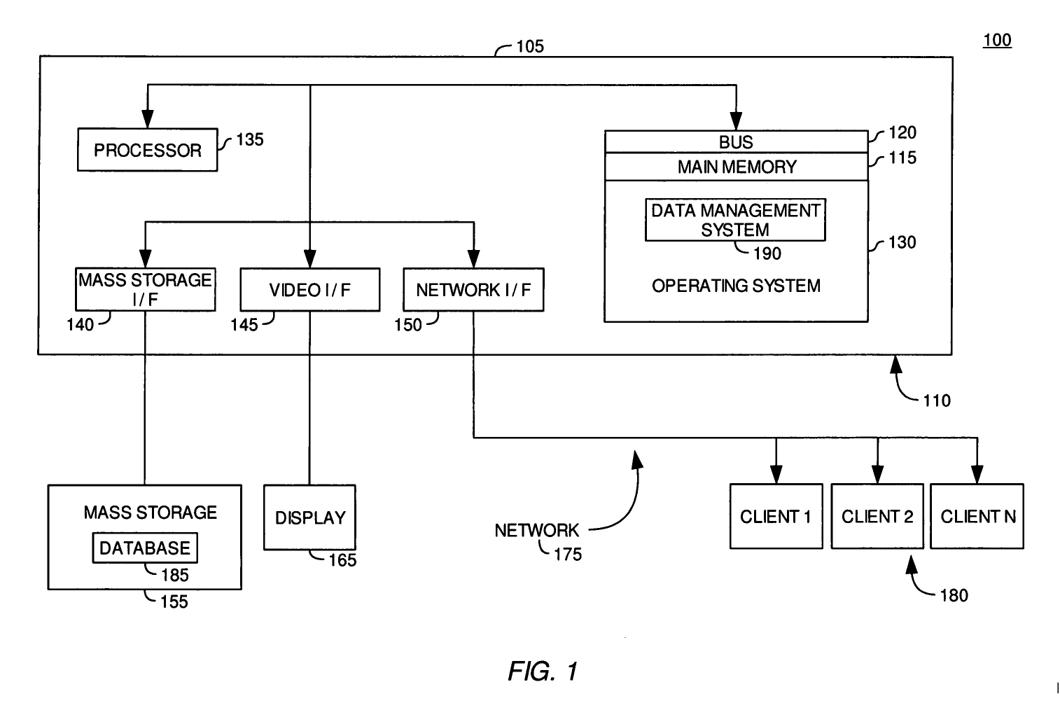

One embodiment of the invention is implemented as a program product for use with a computer system such as, for example, the computer system 100 shown in FIG. 1 and described below. The program(s) of the program product defines functions of the embodiments (including the methods described herein) and can be contained on a variety of signal-bearing media. Illustrative signal-bearing media include, but are not limited to: (i) information permanently stored on non-writable storage media (e.g., read-only memory devices within a computer such as CD-ROM disks readable by a CD-ROM drive); (ii) alterable information stored on writable storage media (e.g., floppy disks within a diskette drive or hard-disk drive); or (iii) information conveyed to a computer by a communications medium, such as through a computer or telephone network, including wireless communications. The latter embodiment specifically includes information downloaded from the Internet and other networks. Such signal-bearing bearing media, when carrying computer-readable instructions that direct the functions of the present invention, represent embodiments of the present invention.

In general, the routines executed to implement the embodiments of the invention, may be part of an operating system or a specific application, component, program, module, object, or sequence of instructions. The computer program of the present invention typically is comprised of a multitude of instructions that will be translated by the native computer into a machine-readable format and hence executable instructions. Also, programs are comprised of variables and data structures that either reside locally to the program or are found in memory or on storage devices. In addition, various programs described hereinafter may be identified based upon the application for which they are implemented in a specific embodiment of the invention. However, it should be appreciated that any particular program nomenclature that follows is used merely for convenience, and thus the invention should not be limited to use solely in any specific application identified and/or implied by such nomenclature.

In the following, reference is made to embodiments of the invention. However, it should be understood that the invention is not limited to specific described embodiments. Instead, any combination of the following features and elements, whether related to different embodiments or not, is contemplated to implement and practice the invention. Furthermore, in various embodiments the invention provides numerous advantages over the prior art. However, although embodiments of the invention may achieve advantages over other possible solutions and/or over the prior art, whether or not a particular advantage is achieved by a given embodiment is not limiting of the invention. Thus, the following aspects, features, embodiments and advantages are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

### Physical View of the Environment

Referring now to FIG. 1, a distributed computing environment 100 is shown. In general, the environment 100 includes a computer system 105 and a network 175. The computer system 105 may represent any type of computer, computer system or other programmable electronic device, including a client computer, a server computer, a portable computer, an embedded controller, a PC-based server, a minicomputer, a midrange computer, a mainframe computer, and other computers adapted to support the methods, apparatus, and article of manufacture of the invention. In one embodiment, the computer system 26 is an eServer iSeries 400 available from International Business Machines of Armonk, N.Y.

Illustratively, the computer system 105 comprises a networked system. However, the computer system 105 may also comprise a standalone device. In any case, it is understood that FIG. 1 is merely one configuration for a computer system. Embodiments of the invention can be adapted to any comparable configuration, regardless of whether the computer system 100 is a complicated multi-user apparatus, a single-user workstation, or a network appliance that does not have non-volatile storage of its own.

Embodiments of the present invention may also be practiced in distributed computing environments in which tasks are performed by remote processing devices linked through a communications network. In a distributed computing environment, program modules may be located in both local and remote memory storage devices. In this regard, the computer system 105 and/or one or more of the networked devices 175 may be thin clients which perform little or no processing.

The computer system 105 could include a number of operators and peripheral systems as shown, for example, by a mass storage interface 140 operably connected to a direct access storage device 155 containing a database 185, by a video interface 145 operably connected to a display 165, and by a network interface 175 operably connected to the plurality of networked devices 170 and 180 via a network 175 (e.g. WAN, LAN). The display 165 may be any video output device for outputting viewable information.

Computer system 105 is shown to include at least one processor 135, which obtains instructions and data via a bus 120 from a main memory 115. The processor 135 could be any processor adapted to support the methods of the invention.

The main memory 115 is any memory sufficiently large to hold the necessary programs and data structures. Main memory 115 could be one or a combination of memory devices, including Random Access Memory, nonvolatile or backup memory, (e.g., programmable or Flash memories, read-only memories, etc.). In addition, memory 115 may be considered to include memory physically located elsewhere in a computer system 105, for example, any storage capacity used as virtual memory or stored on a mass storage device (e.g., direct access storage device 155) or on another computer coupled to the computer system 105 via bus 120.

The memory 115 is shown configured with an operating system 130. The operating system 130 is the software used for managing the operation of the computer system 110. Examples of the operating system 130 include IBM OS/1550®, UNIX, Microsoft Windows®, a distribution of the Linux® operating system, and the like.

The memory 115 further includes one or more data management systems. The data management systems 190 are software products comprising a plurality of instructions that are resident at various times in various memory and storage devices in the computer system 110. When read and executed by one or more processors 135 in the computer system 110, the data management systems 190 cause the computer system 110 to perform the steps necessary to execute steps or elements embodying the various aspects of the invention.

### Relational View of Environment

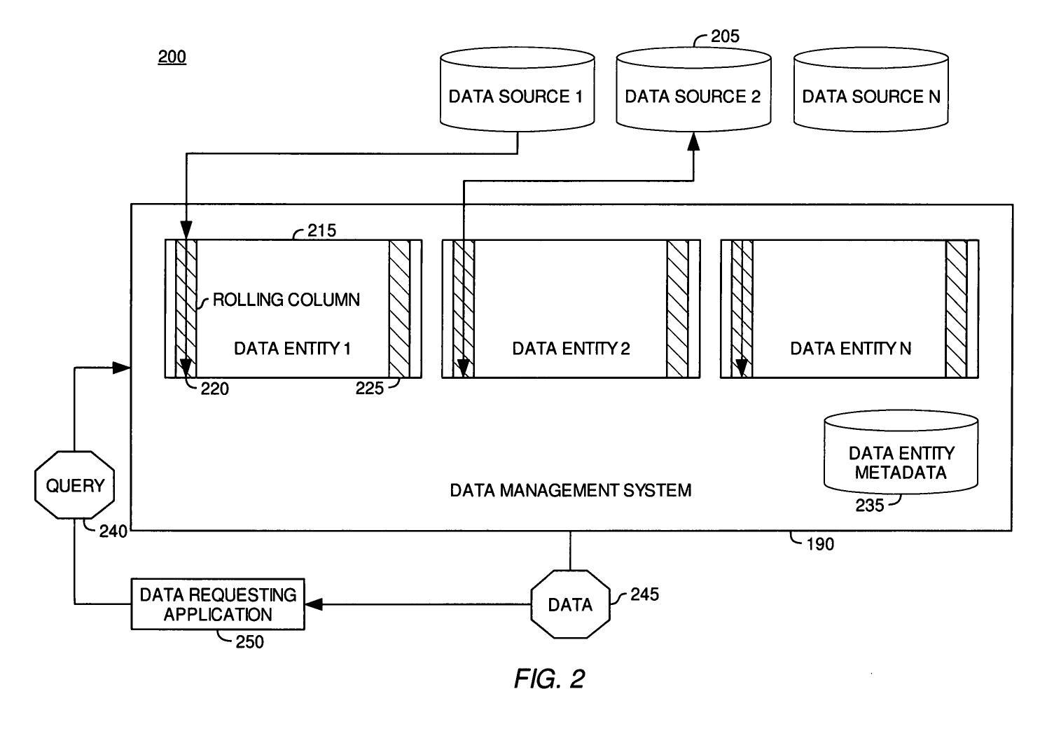

FIG. 2 shows a relational view of a data processing environment 200 that includes a set of software components configured to one embodiment of the invention. In one embodiment, real-time data is generated by a plurality of generic data sources 205₁, 205₂, 205ₙ (three shown by way of example; collectively referred to as data source 205). In one embodiment, the data sources 205 provide the data stored in rolling column 220. A data management system 190 contains a plurality of data entities 215₁, 215₂, 215ₙ (three shown by way of example; collectively referred to as data entity 215). As shown in FIG. 2, an example of the data entity 215 is a relational database table.

The database table 215 may contain a plurality of columns of different types. One column type includes a rolling column 220, configured according to an embodiment of the present invention. Other columns may be non-rolling columns 225. In one embodiment, the rolling column 220 is a database column used to capture and represent data from a real-time data source and, more generally, any type of data for which there is a continuous (or periodic) flow of values (e.g., from data sources 205). Examples of real-time data sources include, among others, patient vital signs monitors, atmospheric weather monitors, and current stock price monitors. The non-rolling column 225 represents any existing database column type that is not a rolling column. In one embodiment, data entity metadata 235 describes how the rolling column 220 collects, stores and returns data. The data entity metadata 235 may include operating instructions to the database specifying whether data is pushed into the rolling column 220 by the data source 205 or pulled from the data source 205 by the rolling column 220. Examples of both the “push” and “pull” scenarios are described in greater detail below. Additionally, the data entity metadata 235 may contain information regarding the time slice of data or the amount of data points that are considered relevant. For example, the metadata may define the rolling column 220 SO that it contains data records received over the last twenty-four hours, or the last thirty-five measurements of a monitored event, or the size (e.g., bytes) of the data stored in the rolling column 220.

In one embodiment, a requesting application 250 may retrieve data from one or more rolling columns 220 by a requesting data via a SQL query 240 or a data feed 245. The application 250 may represent, among others, a data mining or data analysis application configured to analyze data from the database 190, including data from the rolling column. Also, application 250 may represent a query application used to compose database queries submitted to RDBMS 190. Metadata 235 specifies what portion of the data the database management system 190 to return to the data requesting application 250 in response to a request for data from the rolling column 220.

As stated above, data for the rolling column may be “pushed” or “pulled.” An example of data “pushed” into the rolling column 220, includes data provided from a device monitoring the heart rate of a patient. Such a monitoring device may be configured to “push” inserts of data into the rolling column 220. Each time the data source 205 (e.g., the heart monitoring device) receives another data point, the data point is inserted into the database. The data entity metadata 235 specifies that the RDBMS 190 should store data pushed into the column 220 from the heart rate monitoring device.

An example of data “pulled” into the rolling column 220 includes a situation where the database management system 190 obtains, from the data source 205, a current stock price and inserts this information into the rolling column 220. In such a case, the data entity metadata 235 specifies how often the RDBMS 190 should “pull” the stock price from the data source 205. In either the “push” or “pull” scenario, the database management system 190 uses the information in the metadata 235 to determine how to maintain data for a rolling column 220.

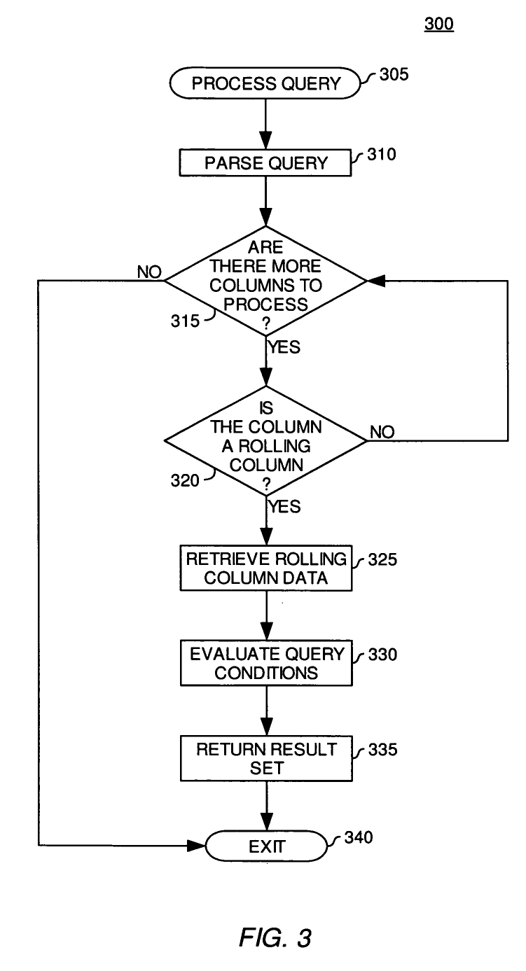

FIG. 3 is a flow chart illustrating a method 300, according to one embodiment of the invention. The database management system 190 may perform the method 300 to process a database query that includes a request for data from the rolling column 220. In step 305, the query is processed using existing database query processing routines. For example, the RDBMS 190 may generate a query plan for the query. At step 310, the query is parsed to identify the columns involved in the query. At step 315, a column identified at step 310 is selected. At step 320, it is determined whether a column under consideration is defined as a rolling column 220. If so, at step 325, the DBMS 190 analyzes the metadata 235 for the rolling column 220 to update the portion of the data stored therein. Processing then returns to step 315 to determine whether additional columns need to be evaluated.

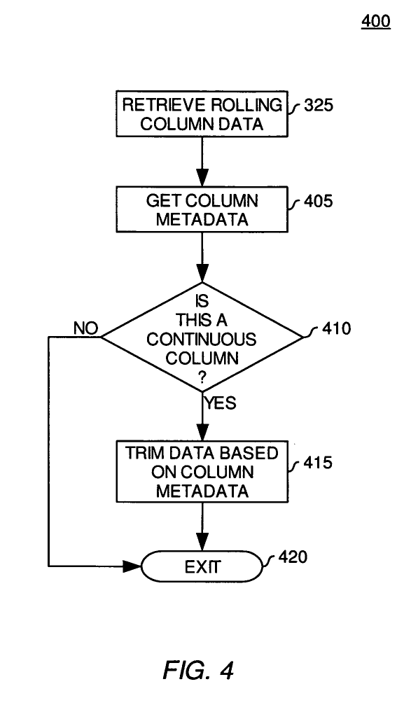

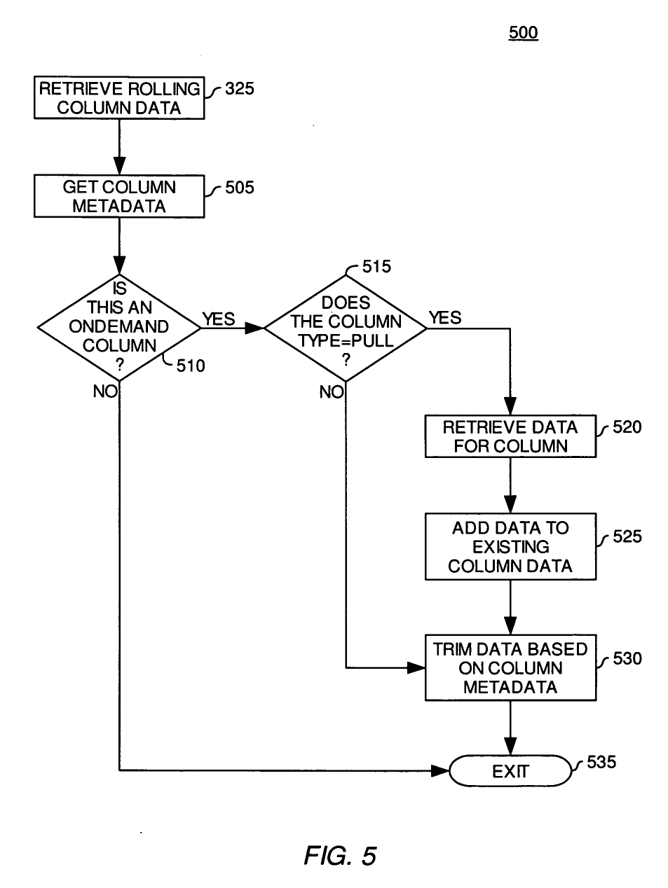

In one embodiment, the metadata 235 may specify a rolling column type of “continuous” or “on-demand.” A “continuous” rolling column 220 is one wherein the data stored in the rolling column is automatically collected for the column, regardless of whether a request for data from the rolling column has been received. Conversely, an “on-demand” rolling column 220 is one wherein the data stored in the rolling column is obtained only when a request is made for data by an outside application 250. FIG. 4, described below, illustrates an example of a rolling column set to a column type of “continuous” and FIG. 5, described below, illustrates an example of a rolling column set to the column type of “on-demand”.

In either case, the column type setting describes how the rolling column should be updated to store the correct portion of the continuum of data, as defined by the metadata 235. After evaluating each of the columns, and updating the data portions reflected in any columns identified as a rolling column 220, processing proceeds from step 315 to step 330. At step 330, once the rolling columns are updated as necessary to include the correct set of data values, the query conditions are evaluated as if the query contained references only non-rolling columns. The database management system 190 obtains the rolling column data and passes the data to the database query execution components. The data may then be analyzed by the query execution components to determine if any of the data meets the query conditions. Results, if any, are returned to the requesting application in step 335. After query results are returned, the method 300 concludes at step 340.

FIG. 4 is a flow chart illustrating a method 400 for returning the correct portion of data from a rolling column 220, according to one embodiment of the invention. The method 400 further illustrates operations that may be performed as part of step 325 of method 300. At step 405, the metadata 235 for the rolling column is retrieved. At step 410, the metadata 235 is used to determine whether the rolling column is a “continuous” column. If the rolling column is not “continuous”, then processing ends at step 420 and additional processing is described below with respect to FIG. 5. Otherwise, if the metadata of the rolling column indicates a “continuous” rolling column, then the data for the column is presumably already stored in the column. In such a case, however, the column may contain more than the relevant time slice, or portion of data specified for the column by metadata 235, as data for a “continuous” column may stored in the column as it becomes available. Accordingly, at step 415 data from the column 220 may be trimmed based on rules that may be included with the metadata 235. That is, data values that fall outside of the definition of the time slice or data portion for the rolling column are “trimmed.” In one embodiment, trimmed data values may be logged to table/column that stores all of the values from continuous feed. Alternatively, trimmed values may simply be discarded. Once trimmed, data from the rolling column 220 may be returned in response to a query request. The method 400 concludes at step 420.

FIG. 5 illustrates a method 500 for returning the correct portion of data from a rolling column 220, according to one embodiment of the invention. The method 500 further illustrates operations that may be performed as part of step 325 of method 300. At step 505, metadata for the rolling column is obtained. At step 510, a determination is made as to whether the rolling column is an “on-demand” column. If the rolling column is not an “on-demand,” column, then method 500 concludes at step 535 (e.g., the column type may be defined as “continuous” and processed according to the method illustrated in FIG. 4).

Otherwise, if the metadata 235 indicates an “on-demand” rolling column, then at step 515, the database management system 190 determines whether the rolling column is a “pull” type or a “push” type. If the column is a “pull” type, then at step 520, data is “pulled” from the data source 205 associated with the rolling column, and processing continues to step 525 where the data retrieved from the data source 205 is appended to existing data in the rolling column. If, on the other hand, the metadata type for the column is not a “pull” type, then the data has presumably already been “pushed” into the column and processing proceeds from step 515 to step 530. At step 530, the data in the rolling column 220 is trimmed, for example, based on additional rules in the metadata 235 defining the rolling column. Once trimmed, data from the column may be returned in response to a query request. The method 500 concludes at step 535.

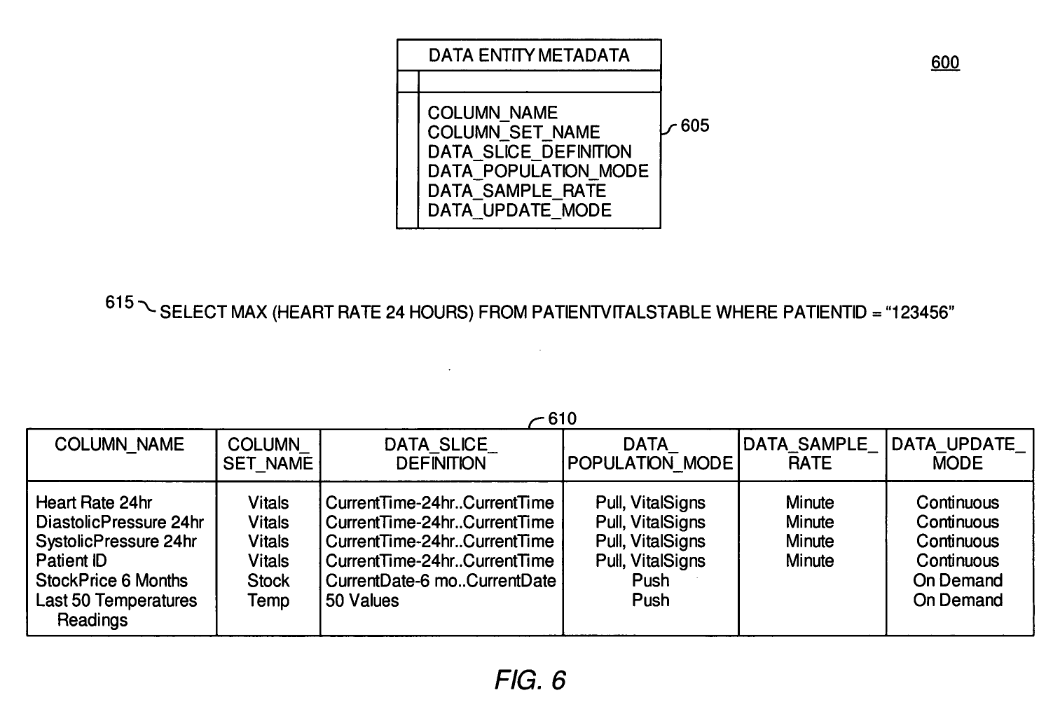

FIGS. 6, 7 and 8, described below, provide an example set of illustrative database schemas used to manage rolling columns in a database management system 190. Other schemas, however, may be used.

FIG. 6 illustrates an exemplary metadata schema 600, for the metadata 235, defining a rolling column within a relational database, according to one embodiment of the invention. As used herein, the term “schema” refers to an arrangement of data. Illustratively, the data entity metadata 605 for a rolling column contains the fields of column_name, column_set_name, data_slice_definition, data_population_mode, data_sample_rate and data_update_mode. Additional examples illustrating the functionality of each the metadata fields 605 are detailed below. The metadata values table 610 displays values for the exemplary data entity metadata fields 605 according to one embodiment of the invention.

Each metadata field contains information used by the database management system 190 to manage different aspects of an exemplary set of rolling columns. For example, column_name could store the name of the rolling column, while column_set_name could contain the name of a set of related rolling columns. In this way, the column_set_name metadata field could allow the database management system 190 to manage multiple rolling columns that each may contain different observations for the same event or same point in time.

Illustratively, the data_slice_definition metadata field may contain the interval of time (time slice) defining a window of time relative to some function of current time (e.g. values for the past hour, values for the past day, etc.). In another embodiment, the data_slice_definition metadata field could contain a maximum number of values to store in a rolling column. Other definitions used to define a portion of data from a larger continuum of data will be readily apparent to one of skill in the art. For example, the data_slice_definition may specify that the data values in rolling column 220 should represent the highest, the lowest, an average, or some other relevant statistical measure or sampling of data values composed using the data values received from data source 205. In such a case, the rolling column 220 may be configured to store a collection of data consistent with a criteria or formula specified by metadata 235.

The data_population_mode metadata field may be used to indicate a data source 205 used to obtain data for a rolling column, and the manner in which the data is obtained for the rolling column. In one embodiment, a value selected from “push” or “pull” may be used for the rolling column. The value of “push” indicates that an external data source 205 is configured to insert new data into the rolling column according to a pre-set update frequency (e.g., every second, twice a minute, once every hour, etc.). The value of “pull” indicates that the data management system 190 is responsible for retrieving and inserting data from an external data source into the rolling column, as defined by metadata 235.

In one embodiment, the data_sample_rate metadata field is referenced when the data_population_mode is set to “pull” and the value for this field may be used to determine the frequency at which new data values are retrieved for the rolling column. As shown, the data_sample_rate metadata field specifies: “vital sign reading per minute.” The database management system 190 is responsible for obtaining current data for the rolling column at the defined frequency set in the data_sample_rate metadata field.

The data_update_mode may store information defining how often the database management system 190 updates the rolling column. In one embodiment, a value of “continuous” indicates that the database management system 190 updates the rolling column on a continuous (or regular-periodic) basis. Thus, the rolling column will always include the latest data. A value of “on-demand” indicates that the database management system 190 should attempt to obtain current data for the rolling column only when requests are received for data in the column. The choice between setting the data_update_mode to “continuous” versus “on-demand” may depend on the needs of the requesting application. While the value of “continuous” for the data_update_mode would generally result in quicker response times to application requests for data, the “continuous” mode would also require greater amounts of system resources from the database management system 190. Likewise, while the value of “on-demand” for the data_update_mode metadata field would generally not require as much system resources from the DBMS 190, additional processing delays could be incurred in returning results back to the requesting application. This may occur because the DBMS 190 would spend time updating an “on-demand” column for each individual query that references data from the rolling column before returning results. Thus, the trade-off provides flexibility to a database administrator.

In one embodiment, an application 250 accesses a rolling column in the same manner as existing columns. For example, users may compose and submit queries via the supported query language of the database management system 190. During query execution, the database management system 190 ensures that the data in any rolling columns included in the query are up to date (e.g., by performing the methods illustrated in FIG. 4 and FIG. 5). For example, any rolling columns in the query with a data_update_mode of “on-demand” may be updated based on the data_slice_definition and data_population_mode metadata values (e.g. retrieve additional data if a data_population_mode of “pull” is specified and remove data which does not fit within the specified data_slice_definition setting). By separating the process by which the data in a rolling column is managed from the applications 250, existing applications and SQL queries may take advantage of rolling columns, as well as more advanced database concepts such as data abstraction layers. For example, for an application to retrieve the maximum relevant heart rate measurement data for a particular patient, SQL query 615 may be executed against the rolling column “Heart Rate 24 Hour” in the table PATIENTVITALSTABLE.

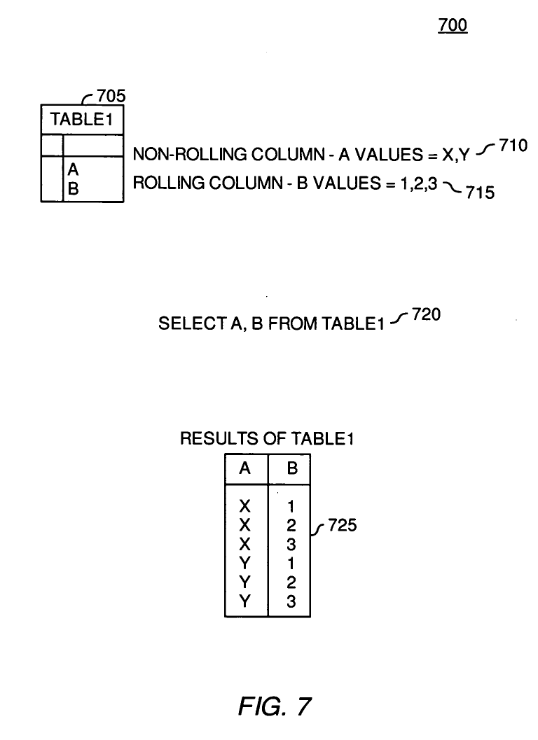

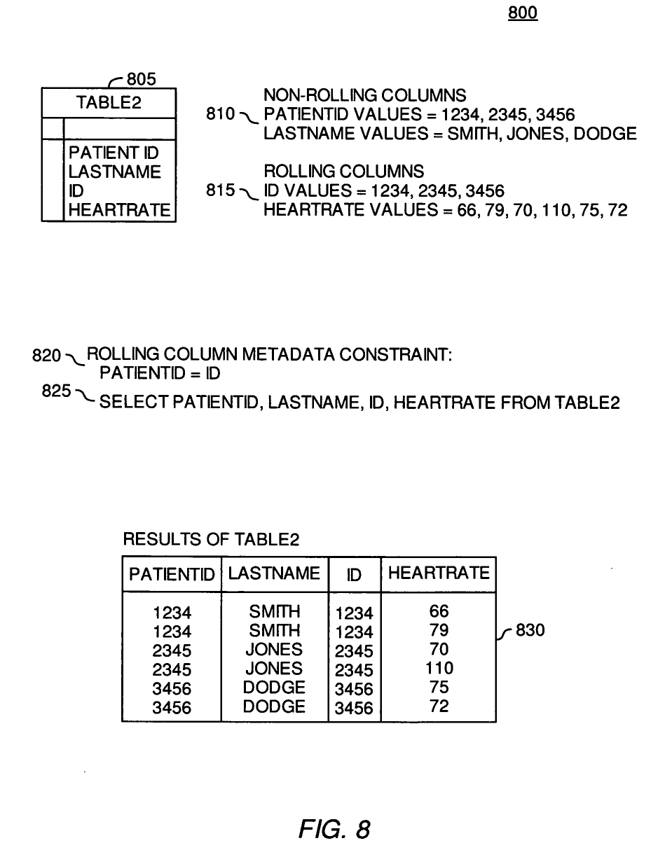

In another embodiment, a table may contain both a rolling column and non-rolling columns, or may contain multiple, independent rolling columns. In order to maintain referential data integrity in the database table containing one of the combinations, at least two approaches may be employed. The first approach may result in a table containing multiple, independent rows for each unique combination of column data. The second approach may include creating column join constraints between columns. FIG. 7 illustrates the first approach and FIG. 8 illustrates the second approach.

FIG. 7 illustrates an exemplary database schema 700. In some cases, there may not be a relationship between a rolling and non-rolling column or multiple rolling columns within a single table. In such a case, data for the rolling and non-rolling columns may be combined to form a composite table. The resulting composite table includes a row for each combination of non-rolling value and individual rolling column value or a row for each combination of unique, independent rolling column values. For example, the database table TABLE1 705 contains the mixed database columns A and B. A is a non-rolling column with the values of X and Y, and B is a rolling column with the values of 1, 2 and 3. As shown, the relevant data in TABLE1 returned by the query 720 would be the result set 725, e.g., the Cartesian product across the rolling and non-rolling column.

FIG. 8 illustrates an exemplary database schema 800. In one embodiment of the invention, an alternate approach may be employed to merge non-rolling and rolling columns without requiring the creation of the Cartesian product of database row entries as described above in FIG. 7. This alternate approach entails identifying join constraints when defining the metadata for rolling columns.

For example, the database table TABLE2 805 contains the two non-rolling columns of PATIENTID and LASTNAME and the associated rolling columns of ID and HEARTRATE. As shown, example values for each column are list to the side of FIG. 8 for better clarity. The approach entails creating a join constraint between a non-rolling column and a rolling column or between independent rolling columns in a table, similar to join constraints between different fields in different tables used currently in existing database systems. It is envisioned that a rolling column metadata constraint 820 can be configured in the metadata of the rolling column to create a relationship between the rolling column data and non-rolling column data. In one embodiment, by setting the metadata constraint of PATIENTID=ID, it could be possible to execute a query similar to the query 825 in order to produce the result set 830 of TABLE2. As shown, by using a join constraint as described above, a table could have both rolling and non-rolling columns without the need to have a row for each unique combination of rolling and non-rolling column data.

### Conclusion

Embodiments of the invention provide time- or volume-oriented portions of a continuum of data within a relational database model using rolling columns. In this way, embodiments of the present invention allow a user to query real-time data continuums, without having to be aware of the mechanisms keeping the data of the rolling column current. As a result, the user may be able to use existing applications to interact with real-time continuums of data in a database management system.

While the foregoing is directed to embodiments of the present invention, other and further embodiments of the invention may be devised without departing from the basic scope thereof, and the scope thereof is determined by the claims that follow.

What is claimed is:

1. A computer-implemented method for representing, within a relational model, a continuum of data received from an external data source, comprising:
defining a set of metadata parameters that define a portion of the continuum of data to store in a rolling column; and
in response to receiving a query that includes a reference to the rolling column, retrieving the metadata parameters defining the portion of the continuum of data to store in the rolling column;
conditionally, updating the rolling column to reflect a correct portion of the continuum of data, according to the metadata parameters; and
processing the database query against the updated rolling column.

2. The method of claim 1, wherein the portion of the continuum of data represents data values collected over a specified time period.

3. The method of claim 1, wherein the portion of the continuum of data represents a specified number of discrete measurements of a continuous data value stored in the rolling column.

4. The method of claim 1, wherein the metadata parameters define the portion of the continuum of data to represent a statistical measure of data composed using data received from the external data source; wherein the statistical measure of data includes at least one of a highest measure, a lowest measure, and an average measure.

5. The method of claim 1 wherein the portion of the continuum of data represents a specified size of data to store in the rolling column.

6. The method of claim 1, wherein the external data source provides a continuous flow of data values to store in the rolling column, and wherein conditionally updating the data values stored in the rolling column comprises trimming the data values in the rolling column.

7. The method of claim 1, wherein the external data source is a real time-data source providing a continuous measurement of a data value to the database management system that includes the rolling column.

8. The method of claim 1, wherein the rolling column is configured to pull data values from the external data source into the rolling column at periodic intervals defined by the metadata parameters.

9. The method of claim 1, wherein the rolling column is configured to receive data values pushed from the external data source into the rolling column.

10. The method of claim 1, wherein conditionally updating the rolling column comprises, determining whether the metadata specifies a continuous or on demand mode for the rolling column, and wherein the continuous mode results in the rolling column being updated on a continuous basis, without waiting for a request for data from the rolling column, and wherein the on on-demand mode results in a database management system updating the data used to populate the rolling column data only in response to receiving the query that includes a reference to the rolling column.

11. A tangible computer-readable storage medium containing a program which, when executed by a processor, performs operations for representing, within a relational model, a continuum of data received from an external data source, comprising:
in response to receiving a query that includes a reference to a rolling column:
retrieving metadata parameters defining a portion of the continuum of data to store in the rolling column;
updating the rolling column to reflect a correct portion of the continuum of data, according to the metadata parameters; and
processing the database query against the updated rolling column.

12. The computer-readable medium of claim 11, wherein the portion of the continuum of data represents data values collected over a specified time period.

13. The computer-readable medium of claim 11, wherein the portion of the continuum of data represents a specified number of discrete measurements of a continuous data value stored in the rolling column.

14. The computer-readable medium of claim 11, wherein the portion of the continuum of data represents a specified size of data to store in the rolling column.

15. The computer-readable medium of claim 11, wherein the metadata parameters define the portion of the continuum of data to represent a statistical measure of data composed using data received from the external data source; wherein the statistical measure of data includes at least one of a highest measure, a lowest measure, and an average measure.

16. The computer-readable medium of claim 11, wherein the external data source provides a continuous flow of data values to store in the rolling column, and wherein conditionally updating the data values stored in the rolling column comprises trimming the data values in the rolling column.

17. The computer-readable medium of claim 11, wherein the external data source is a real time-data source providing a continuous measurement of a data value to the database management system that includes the rolling column.

18. The computer-readable medium of claim 11, wherein the rolling column is configured to pull data values from the external data source into the rolling column at periodic intervals defined by the metadata parameters.

19. The computer-readable medium of claim 11, wherein the rolling column is configured to receive data values pushed from the external data source into the rolling column.

20. The computer-readable medium of claim 11, wherein the operation of conditionally updating the rolling column comprises, determining whether the metadata specifies a continuous or on demand mode for the rolling column, and wherein the continuous mode results in the rolling column being updated on a continuous basis, without waiting for a request for data from the rolling column, and wherein the on on-demand mode results in a database management system updating the data used to populate the rolling column data only in response to receiving the query that includes a reference to the rolling column.

21. A computing device comprising:
a processor; and
a memory configured to store an application that includes instructions which, when executed by the processor, cause the processor to perform operations for representing continuum of data received from an external data source as a rolling column within a relational model, comprising:
in response to receiving a query that includes a reference to the rolling column;
(i) retrieving metadata parameters defining a portion of the continuum of data to store in the rolling column;
(ii) updating the rolling column to reflect a correct portion of the continuum of data, according to the metadata parameters; and
(iii) processing the database query against the updated rolling column.

22. The computing device of claim 21, wherein the rolling column is configured to pull data values from the external data source into the rolling column at periodic intervals defined by the metadata parameters.

23. The computing device of claim 21, wherein the rolling column is configured to receive data values pushed from the external data source into the rolling column.
